(19) United States
(12) Patent Application Publication
(10) Pub. No.: US 2020/0408249 A1
(43) Pub. Date: Dec. 31, 2020

(54) FLUID DYNAMIC BEARING AND METHOD OF MANUFACTURING THE SAME

(71) Applicant: NTN CORPORATION, Osaka (JP)

(72) Inventor: Shinji KOMATSUBARA, Mie (JP)

(21) Appl. No.: 16/976,261

(22) PCT Filed: Mar. 5, 2019
(86) PCT No.: PCT/JP2019/008611

§ 371 Date: Aug. 27, 2020

(30) Foreign Application Priority Data
Mar. 8, 2018 (JP) 2018-042065

(51) Int. Cl. F16C 17/10; F16C 33/14

(52) U.S. Cl. CPC F16C 17/102; F16C 33/14

(57) ABSTRACT

A fluid dynamic bearing 8 includes a green compact 10 of a raw material powder M including as a main component a metal powder capable of forming an oxide film 12, and dynamic pressure generating portions A1 and A2 provided in a region 8a where a bearing gap is formed between a surface of the green compact 10 and a supported portion 2a1, and the oxide film 12 formed between particles 11 of the metal powder, and the fluid dynamic bearing 8 exhibits a radial crushing strength of 150 MPa or more. Here, the metal powder is used which exhibits a particle size distribution in which a ratio of the metal powder of 100 μm or more to the metal powder as a whole is 30 wt % or more, and a cumulative 50% diameter is 50 μm or more and 100 μm or less.

### TECHNICAL FIELD

The present invention relates to a fluid dynamic bearing and a method of manufacturing the same, and more particularly to a fluid dynamic bearing having a green compact of a metal powder as a base and a method of manufacturing the same.

### BACKGROUND ART

As is well known, a fluid dynamic bearing has a dynamic pressure generating portion that generates a dynamic pressure action on a lubricating fluid (for example, lubricating oil) in a bearing gap formed between the fluid dynamic bearing and a supported portion such as an outer peripheral surface of a shaft. Some fluid dynamic bearings of this type are formed of a metal porous body, and a radial dynamic pressure generating portion that generates a dynamic pressure action in the radial bearing gap formed between the fluid dynamic bearing and the supported portion is formed on an inner peripheral surface of the porous body. In other fluid dynamic bearings, a thrust dynamic pressure generating portion that generates a dynamic pressure action in a thrust bearing gap formed between the fluid dynamic bearing and the supported portion is formed.

The above fluid dynamic bearing having a porous structure is generally manufactured by sintering a green compact obtained by compression-molding a raw material powder including a metal powder as a main component, and then forming a radial dynamic pressure generating portion by molding on an inner peripheral surface of a sintered body obtained by sintering (for example, see Patent Literature 1). Alternatively, a method has been proposed in which a fluid dynamic bearing having a porous structure is manufactured by compressing a raw material powder to mold a green compact, at the same time, molding a radial dynamic pressure generating portion on an inner peripheral surface of the green compact, and then sintering this green compact (see Patent Literature 2).

As described above, in a manufacturing process of a fluid dynamic bearing having a porous structure manufactured from a metal powder, a sintering step is provided in order to ensure a strength required for a fluid dynamic bearing. However, in the sintering step, the green compact is heated in an extremely high-temperature environment (generally 800° C. or higher). This causes an unacceptably large dimensional change in the sintered green compact (sintered body) due to heat shrinkage after sintering or the like. Consequently, in order to secure dimensional accuracy and shape accuracy required for a fluid dynamic bearing, it is essential to perform a dimensional correction process (shaping process) such as sizing on the sintered body, and this subsequent process increases costs.

In order to solve this problem, Patent Literature 3 discloses a fluid dynamic bearing manufactured without going through a sintering step. In other words, this fluid dynamic bearing is a fluid dynamic bearing having as a base a green compact of a raw material powder including a metal powder capable of forming an oxide film, and having a dynamic pressure generating portion formed by molding in a region of a surface of the green compact that is a bearing surface, in which the oxide film is formed between particles of the metal powder configuring the green compact, and the oxide film is formed by a steam treatment of the green compact.

As described above, the oxide film formed between the particles of the metal powder by the steam treatment functions as a binding medium between the particles and takes a role of necking formed when the green compact is sintered. It is thus possible to increase the strength of the green compact to a level where the green compact can be used as a fluid dynamic bearing as it is, or for example, to a level where the radial crushing strength is 150 MPa or more. Further, in the steam treatment to be performed on the green compact, the treatment temperature is significantly lower than a heating temperature for sintering the green compact. It is therefore possible to reduce an amount of dimensional change of the green compact after the treatment. Thus, the fluid dynamic bearing having the above configuration can omit the shaping process such as sizing, which has been essential after the sintering step, and reduce the manufacturing cost. Further, when the treatment temperature is low, the energy required for the treatment can be reduced, which enables a cost reduction.

### CITATIONS LIST

### Patent Literature

Patent Literature 1: JP 3607661 B2

Patent Literature 2: JP 2000-65065 A

Patent Literature 3: JP 2016-102553 A

### SUMMARY OF INVENTION

### Technical Problems

By the way, when a fluid dynamic bearing is manufactured by the method disclosed in Patent Literature 3, for example, an iron powder may be mixed and used as a metal powder capable of forming an oxide film, and a copper powder may be mixed and used as a metal powder for improving moldability and conformability with a shaft (initial sliding property). However, it has been found that when a green compact is molded from a raw material powder having such a material composition (composition including a metal powder different from the metal powder capable of forming an oxide film), and the green compact is subjected to the steam treatment, the dimensional accuracy (or shape accuracy) after the steam treatment is reduced. Here, according to the findings, for example, use of an iron powder exhibiting a distribution in which a particle diameter is entirely small (20 μm to 100 μm) can avoid reduction of the dimensional accuracy. On the other hand, use of fine powder as described above deteriorates the moldability of the green compact and generates a crack called lamination on an outer surface of the green compact. This kind of crack may progress when an impact or vibration is applied, which may eventually damage the bearing. The occurrence of lamination is therefore a problem to be avoided.

In view of the above situation, it is a technological object to be achieved in the present invention to provide a low-cost fluid dynamic bearing that avoids the occurrence of lamination, has the strength sufficient to endure actual use, and can stably exhibit the desired bearing performance.

### Solutions to Problems

The above problem can be solved by a fluid dynamic bearing of the present invention. In other words, this bearing includes a green compact of a raw material powder including a metal powder as a main component capable of forming an oxide film, a dynamic pressure generating portion provided in a region of a surface of the green compact where a bearing gap is formed between the surface of the green compact and a supported portion, and the oxide film formed between particles of the metal powder, the fluid dynamic bearing having a radial crushing strength of 150 MPa or more, in which the metal powder exhibits a particle size distribution in which a ratio of the metal powder of 100 μm or more to the metal powder as a whole is 30 wt % or more, and a cumulative 50% diameter is 50 μm or more and 100 μm or less.

The “cumulative 50% diameter” in the present invention is a median value (also referred to as median diameter) in a cumulative distribution of values of particle diameters measured by a particle size distribution measuring device using a laser diffraction and scattering method as a measurement principle. Further, the “metal powder capable of forming an oxide film” in the present invention is, in other words, a metal powder having a larger ionization tendency than that of hydrogen, such as iron, aluminum, magnesium, and chromium powders, or an alloy powder including the above metal. The term “including as a main component” in the present invention means that, when the raw material powder includes a plurality of substances, the ratio of the metal powder to the entire raw material powder is the largest among the plurality of substances. When the raw material powder includes only a single substance, the single substance corresponds to the metal powder capable of forming the oxide film. Further, the “radial crushing strength” in the present invention is a value calculated on the basis of the method specified in JIS Z 2507.

Thus, in the fluid dynamic bearing of the present invention, a metal powder is used which exhibits a particle size distribution in which the ratio of the metal powder of 100 μm or more to the metal powder as a whole is 30 wt % or more, and the cumulative 50% diameter is 50 μm or more and 100 μm or less, as the metal powder that is the main component of the raw material powder and is capable of forming the oxide film. Thus, by using the metal powder exhibiting the particle size distribution in which the ratio of the metal powder of 100 μm or more to the metal powder as a whole is 30 wt % or more, it is possible to avoid occurrence of lamination as much as possible due to the mixture of a powder having a relatively fine particle diameter. Further, in addition to the above distribution, by using a metal powder exhibiting a particle size distribution in which a cumulative 50% diameter is 50 μm or more and 100 μm or less, the particle diameter of the metal powder is entirely increased. It is therefore possible to prevent the internal pores of the green compact from becoming excessively large. As a result, for example, when the oxide film is formed by the subsequent heat treatment, the formation of the oxide film effectively seals or reduces the internal pores, and a dynamic pressure is prevented from escaping to the inside of the bearing (decrease in rigidity of a fluid film formed in the bearing gap) as much as possible. This allows desired bearing performance to be exhibited stably.

In the fluid dynamic bearing of the present invention, the oxide film formed between the particles of the metal powder functions as a binding medium between the particles, and takes a role of necking formed when the green compact is sintered. The fluid dynamic bearing thus exhibits a radial crushing strength of 150 MPa or more. The fluid dynamic bearing can be thus used as it is as the fluid dynamic bearing without being subjected to a treatment such as sintering. This can simplify a manufacturing process and reduce manufacturing costs.

Further, in the fluid dynamic bearing of the present invention, the metal powder may be a reduced powder.

The reduced powder generally has a distorted shape (for example, a shape with great irregularities on a surface) as compared with an atomized powder. Thus, by using the reduced powder, the particles of the reduced powder are closely entangled during green compacting, and the green compact having a high strength can be obtained. The dimensional change during sintering shows that the reduced powder is more likely to shrink than the powder produced by an atomizing method (atomized powder), but the fluid dynamic bearing of the present invention can be manufactured without undergoing the sintering step. Thus, shrinkage during sintering need not be particularly concerned.

Further, in the fluid dynamic bearing of the present invention, the metal powder may be an iron powder.

The oxide film can be effectively formed between the particles of the iron powder of the green compact by using the iron powder as the metal powder because iron is a metal having a high ionization tendency. Further, an iron powder, which is available at a low price, is preferable in terms of material cost.

Further, in the fluid dynamic bearing of the present invention, the rate of the metal powder to the entire raw material powder may be 95 wt % or more.

In this way, the metal powder exhibiting the above particle size distribution is used as the metal powder capable of forming the oxide film, and the ratio of the metal powder to the entire raw material powder is set to 95 wt % or more. This can avoid occurrence of lamination and more effectively suppress a decrease in dimensional accuracy (or shape accuracy) after the heat treatment for forming the film.

Further, in the fluid dynamic bearing of the present invention, the fluid dynamic bearing may be formed by impregnating internal pores of the green compact with a lubricating oil.

In the present invention, by using the metal powder exhibiting the above particle size distribution, it is possible to avoid a situation in which the internal pores of the green compact become excessively large. Thus, while the internal pores remain in the green compact at a constant ratio, the internal pores can be prevented from becoming large. Thus, while a required amount of lubricating oil is retained in the internal pores of the green compact, the dynamic pressure can be prevented from escaping to the inside of the bearing as much as possible. This allows excellent bearing performance to be exhibited stably over a long period of time.

The fluid dynamic bearing described above can be suitably provided as a fluid dynamic bearing device including, for example, the fluid dynamic bearing and a shaft member that rotates relative to the fluid dynamic bearing including the supported portion.

Further, the fluid dynamic bearing device having the above configuration can be suitably provided as, for example, a motor including the fluid dynamic bearing device.

Further, the problem can be also solved by a method of manufacturing a fluid dynamic bearing of the present invention. In other words, this manufacturing method is a method of manufacturing a fluid dynamic bearing having a radial crushing strength of 150 MPa or more, the method including a compression molding step of compressing a raw material powder including as a main component a metal powder capable of forming an oxide film to mold a green compact, and molding a dynamic pressure generating portion in a region where a bearing gap is formed between a surface of the green compact and a supported portion, and a film forming step of performing a predetermined heat treatment on the green compact, and forming the oxide film between particles of the metal powder configuring the green compact, in which as the metal powder, a metal powder is used which exhibits a particle size distribution in which a ratio of the metal powder of 100 μm or more to the metal powder as a whole is 30 wt % or more, and a cumulative 50% diameter is 50 μm or more and 100 μm or less.

As described above, also in the method of manufacturing a fluid dynamic bearing of the present invention, as the metal powder that is the main component of the raw material powder and is capable of forming an oxide film, by using a metal powder exhibiting a particle size distribution in which the ratio of the metal powder of 100 μm or more to the metal powder as a whole is 30 wt % or more, it is possible to avoid occurrence of lamination as much as possible due to the mixture of a powder having a relatively fine particle diameter. Further, in addition to the above distribution, by using a metal powder exhibiting the particle size distribution in which a cumulative 50% diameter is 50 μm or more and 100 μm or less, the particle diameter of the metal powder is entirely increased. It is therefore possible to prevent the internal pores of the green compact from becoming excessively large. As a result, when the oxide film is formed by the subsequent heat treatment, the formation of the oxide film effectively seals the internal pores, and a dynamic pressure is prevented from escaping to the inside of the bearing (decrease in rigidity of a fluid film formed in the bearing gap) as much as possible. This allows desired bearing performance to be stably exhibited.

In the method of manufacturing a fluid dynamic bearing of the present invention, in the film forming step, the green compact may be subjected to a low-temperature heat treatment in an air atmosphere as the predetermined heat treatment. Further, in this case, the treatment temperature of the low-temperature heat treatment may be set to 350° C. or higher and 600° C. or lower.

In this way, by performing the low-temperature heat treatment as the predetermined heat treatment in the air atmosphere, the treatment temperature in the film forming step can be significantly lower than the heating temperature in the case of sintering the green compact. As a result, an amount of dimensional change of the green compact after the heat treatment can be reduced, and a shaping process such as sizing can be omitted.

### Advantageous Effects of Invention

As described above, according to the present invention, it is possible to provide a low-cost fluid dynamic bearing that avoids the occurrence of lamination, has the strength sufficient to endure actual use, and can stably exhibit the desired bearing performance.

### BRIEF DESCRIPTION OF DRAWINGS

FIG. 1 is a cross-sectional view of a fluid dynamic bearing device according to one embodiment of the present invention.

FIG. 2 is a cross-sectional view of the fluid dynamic bearing shown in FIG. 1.

FIG. 3 is a plan view showing a lower end surface of the fluid dynamic bearing shown in FIG. 1.

FIG. 4 is an enlarged sectional view of a main part of the fluid dynamic bearing shown in FIG. 1.

FIG. 5A is a diagram showing an initial stage of a compression molding step of a green compact that is a base of the fluid dynamic bearing.

FIG. 5B is a diagram showing an intermediate stage of the compression molding step of the green compact that is the base of the fluid dynamic bearing.

FIG. 6 is a graph conceptually showing a particle size distribution of a metal powder of the present invention by a frequency distribution.

FIG. 7 is a graph conceptually showing the particle size distribution of the metal powder of the present invention by a cumulative distribution.

FIG. 8 is a diagram conceptually showing a device that measures oil permeability.

### DESCRIPTION OF EMBODIMENT

Hereinafter, one embodiment of the present invention will be described with reference to the drawings.

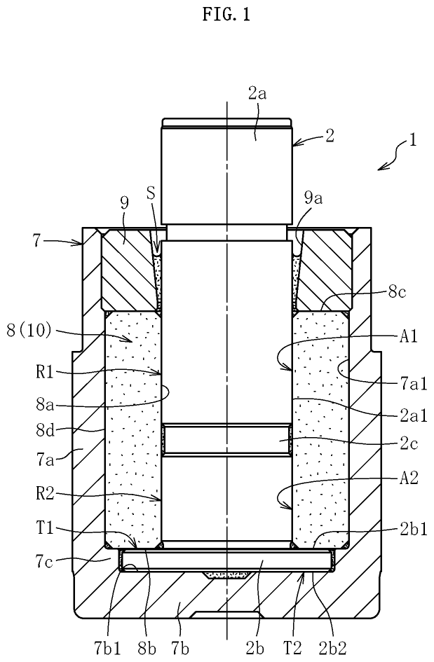

FIG. 1 is a cross-sectional view of a fluid dynamic bearing device 1 according to one embodiment of the present invention. The fluid dynamic bearing device 1 includes a fluid dynamic bearing 8, a shaft member 2 that is inserted into an inner periphery of the fluid dynamic bearing 8 and rotates with respect to the fluid dynamic bearing 8, a bottomed cylindrical housing 7 that holds the fluid dynamic bearing 8 in an inner periphery thereof, and a seal member 9 that seals an opening of the housing 7. An internal space of the housing 7 is filled with a lubricating oil (shown by dense scattered point hatching) as a lubricating fluid. In the following description, for convenience, a side on which the seal member 9 is provided is a upper side, and an opposite side in an axial direction is a lower side.

The housing 7 has a bottomed cylindrical shape that integrally includes a cylindrical portion 7a having a cylindrical shape and a bottom portion 7b that closes a lower end opening of the cylindrical portion 7a. A step portion 7c is provided at a boundary between the cylindrical portion 7a and the bottom portion 7b, and a lower end surface 8b of the fluid dynamic bearing 8 is in contact with an upper end surface of the step portion 7c. This sets an axial position of the fluid dynamic bearing 8 with respect to the housing 7.

An inner bottom surface 7b1 of the bottom portion 7b is provided with an annular thrust bearing surface that forms a thrust bearing gap of a thrust bearing portion T2 between inner bottom surface 7b1 and an opposing lower end surface 2b2 of the flange portion 2b of the shaft member 2. A dynamic pressure generating portion (thrust dynamic pressure generating portion) that generates a dynamic pressure action on the lubricating oil in the thrust bearing gap of the thrust bearing portion T2 is provided on the thrust bearing surface. Although not shown in the drawings, the thrust dynamic pressure generating portion is configured, for example, by alternately arranging spiral dynamic pressure generating grooves and convex hill portions that define the dynamic pressure generating grooves in a circumferential direction, similarly to the thrust dynamic pressure generating portion B described later.

The seal member 9 is formed in an annular shape, and is fixed to an inner peripheral surface 7a1 of the cylindrical portion 7a of the housing 7 by an appropriate means. An inner peripheral surface 9a of the seal member 9 is formed in a tapered surface shape having a diameter gradually reduced downward. A seal space S having a radial dimension gradually reduced downward is formed between the inner peripheral surface 9a and an opposing outer peripheral surface 2a1 of the shaft member 2. The seal space S has a buffer function of absorbing a volume change amount of the lubricating oil filled in the internal space of the housing 7 due to a temperature change, and constantly holds an oil surface of the lubricating oil within an axial range of the space S in a range of an assumed temperature change.

The shaft member 2 includes a shaft portion 2a and a flange portion 2b integrally or separately provided at a lower end of the shaft portion 2a. Of the outer peripheral surface 2a1 of the shaft portion 2a, a part facing an inner peripheral surface 8a of the fluid dynamic bearing 8 is formed in an even and smooth cylindrical surface although being provided with a cylindrical surface-shaped inner recess portion 2c having a relatively small diameter. Further, an upper end surface 2b1 and the lower end surface 2b2 of the flange portion 2b are formed into smooth flat surfaces.

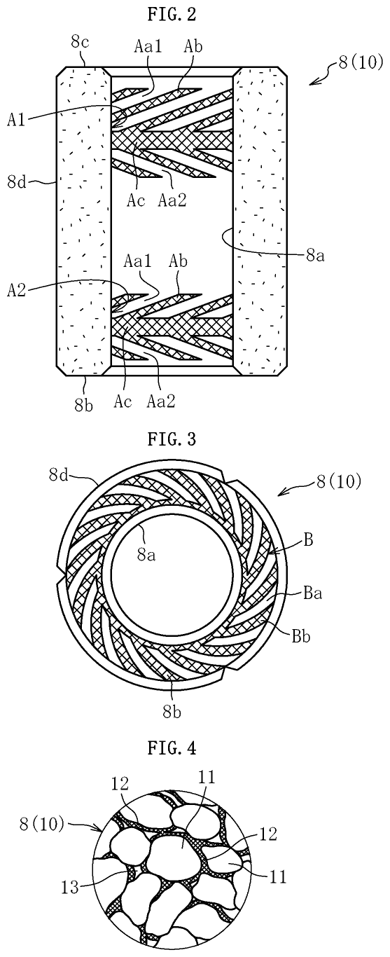

The fluid dynamic bearing 8 has a cylindrical shape in this embodiment, and is fixed to the inner peripheral surface of the housing 7 by an appropriate means. On the inner peripheral surface 8a of the fluid dynamic bearing 8, cylindrical radial bearing surfaces that form radial bearing gaps of the radial bearing portions R1 and R2 between the inner peripheral surface 8a and the opposing outer peripheral surface 2a1 of the shaft portion 2a are provided apart from each other at two axial positions. As shown in FIG. 2, radial dynamic pressure generating portions A1 and A2 that generate a dynamic pressure action on the lubricating oil in the radial bearing gaps are formed on the two respective radial bearing surfaces. The radial dynamic pressure generating portions A1 and A2 are each configured by a plurality of upper dynamic pressure generating grooves Aa1 inclined with respect to the axial direction, a plurality of lower dynamic pressure generating grooves Aa2 inclined in a direction opposite to the upper dynamic pressure generating grooves Aa1, and the convex hill portions that define the dynamic pressure generating grooves Aa1 and Aa2. The dynamic pressure generating grooves Aa1 and Aa2 are arranged in a herringbone shape as a whole. The hill portions include inclined hill portions Ab provided between the dynamic pressure generating grooves adjacent in a circumferential direction and annular hill portions Ac provided between the upper and lower dynamic pressure generating grooves Aa1 and Aa2 and having a diameter substantially identical to that of the inclined hill portions Ab.

On the lower end surface 8b of the fluid dynamic bearing 8, an annular thrust bearing surface that forms a thrust bearing gap of a thrust bearing portion T1 is provided between the lower end surface 8b and the opposing upper end surface 2b1 of the flange portion 2b. As shown in FIG. 3, the dynamic pressure generating portion (thrust dynamic pressure generating portion) B that generates a dynamic pressure action on the lubricating oil in the thrust bearing gap of the thrust bearing portion T1 is provided on the thrust bearing surface. The thrust dynamic pressure generating portion B of the illustrated example is configured by alternately arranging spiral dynamic pressure generating grooves Ba and convex hill portions Bb that the dynamic pressure generating grooves Ba in the circumferential direction.

In the fluid dynamic bearing device 1 having the above configuration, before a relative rotation of the shaft member 2 and the fluid dynamic bearing 8 is started, the radial bearing gaps are formed between the two radial bearing surfaces provided on the inner peripheral surface 8a of the fluid dynamic bearing 8 and the opposing outer peripheral surface 2a1 of the shaft portion 2a. Then, as the relative rotation of the shaft member 2 and the fluid dynamic bearing 8 is started, the dynamic pressure action of the radial dynamic pressure generating portions A1 and A2 (dynamic pressure generating grooves Aa1 and Aa2) increases a pressure of an oil film formed in the two radial bearing gaps. As a result, the radial bearing portions R1 and R2 that support the shaft member 2 relatively rotatably in a radial direction in a non-contact manner are formed apart from each other at two axial positions. At this time, the inner recess portion 2c provided on the outer peripheral surface 2a1 of the shaft portion 2a forms a cylindrical lubricating oil reservoir between the two radial bearing gaps. This can prevent a shortage of the oil film between the radial bearing gaps, which is deterioration of bearing performance of the radial bearing portions R1 and R2 as much as possible.

Before the relative rotation of the shaft member 2 and the fluid dynamic bearing 8 is started, the thrust bearing gaps are respectively formed between the thrust bearing surface provided on the lower end surface 8b of the fluid dynamic bearing 8 and the upper end surface 2b1 of the flange portion 2b facing the thrust bearing surface, and between the inner bottom surface 7b1 of the bottom portion 7b of the housing 7 and the lower end surface 2b2 of the flange portion 2b facing the inner bottom surface 7b1. Then, as the relative rotation of the shaft member 2 is started, the dynamic pressure action of the thrust dynamic pressure generating portion B (dynamic pressure generating grooves Ba) of the lower end surface 8b and the thrust dynamic pressure generating portion of the inner bottom surface 7b1 increases the pressure of the oil film formed in the two thrust bearing gaps. As a result, the thrust bearing portions T1 and T2 that support the shaft member 2 relatively rotatably in one and the other thrust directions in a non-contact manner.

Although not shown in the drawings, the fluid dynamic bearing device 1 described above is used as a bearing device for a motor such as (1) a spindle motor for a disk device such as an HDD, (2) a polygon scanner motor for a laser beam printer (LBP), or (3) a fan motor for a PC. In a case of (1), for example, a disk hub having a disk mounting surface is provided on the shaft member 2 integrally or separately, and in a case of (2), for example, a polygon mirror is provided on the shaft member 2 integrally or separately. Further, in a case of (3), for example, a fan having a blade on the shaft member 2 is provided integrally or separately.

In the fluid dynamic bearing device 1 described above, the fluid dynamic bearing 8 has a characteristic configuration. Hereinafter, a structure and manufacturing method of the fluid dynamic bearing 8 according to an example of the present invention will be described in detail.

The fluid dynamic bearing 8 is provided as a base with a green compact 10 of a raw material powder including as a main component a metal powder (here, iron powder) capable of forming an oxide film. In this embodiment, the fluid dynamic bearing 8 further includes the radial dynamic pressure generating portions A1 and A2 provided on the inner peripheral surface 8a and the thrust dynamic pressure generating portion B provided on the lower end surface 8b. A relative density of the green compact 10 is set to, for example, equal to or more than 80%. Here, as schematically shown in FIG. 4 which is an enlarged cross-sectional view of a main part thereof, the fluid dynamic bearing 8 has an oxide film 12 formed between the particles 11 of a metal powder (for example, iron powder particles) capable of forming the oxide film 12 (more specifically, the oxide film 12 formed on a surface of the particles 11 of each metal powder, with the particles 11 adjacent to each other bonded). The fluid dynamic bearing 8 has a strength sufficient for use by being incorporated into the fluid dynamic bearing device 1, or specifically, a radial crushing strength of 150 MPa or more. The fluid dynamic bearing 8 having the above configuration is manufactured, for example, through a compression molding step, a film forming step, and an oil impregnation step in that order. Hereinafter, each step will be described in detail.

### [Compression Molding Step]

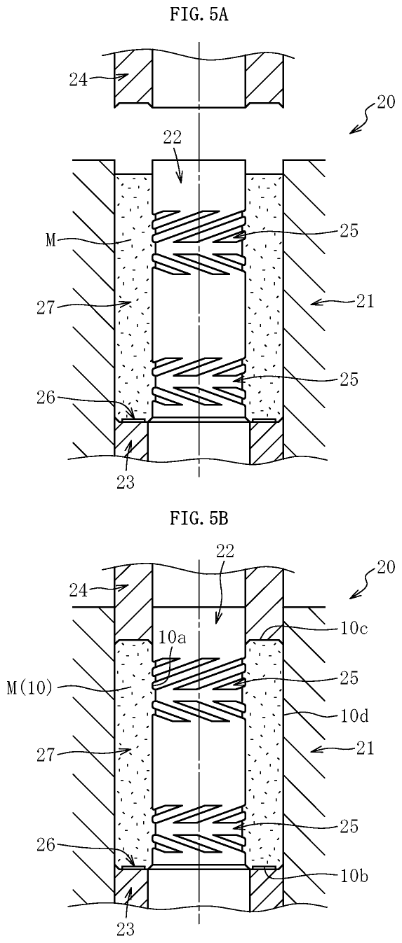

In the compression molding step, by compressing a raw material powder including as a main component a metal powder capable of forming an oxide film, the green compact 10 is obtained in which the radial dynamic pressure generating portions A1 and A2 are molded on an inner peripheral surface 10a forming a bearing gap between the inner peripheral surface 10a and the outer peripheral surface 2a1 of the shaft portion 2a as a supported portion, and the thrust dynamic pressure generating portion B is molded on a lower end surface 10b forming a bearing gap between the lower end surface 10b and the upper end surface 2b1 of the flange portion 2b as a supported portion. Here, the inner peripheral surface 10a of the green compact 10 corresponds to the inner peripheral surface 8a of the fluid dynamic bearing 8, and the lower end surface 10b of the green compact 10 corresponds to the lower end surface 8b of the fluid dynamic bearing 8. An outer peripheral surface 10d of the green compact 10 described later corresponds to an outer peripheral surface 8d of the fluid dynamic bearing 8, and an upper end surface 10c of the green compact 10 corresponds to an upper end surface 8c of the fluid dynamic bearing 8. The green compact 10 having the above configuration can be molded by, for example, a uniaxial pressure molding method. Specifically, the green compact 10 can be obtained by using a molding die device 20 as shown in FIGS. 5A and 5B. The molding die device 20 includes a cylindrical die 21 that molds the outer peripheral surface 10d of the green compact 10, a core pin 22 that is arranged on an inner periphery of the die 21 and molds the inner peripheral surface 10a of the green compact 10, and a pair of lower punch 23 and upper punch 24 that molds the lower end surface 10b and the upper end surface 10c of the green compact 10. The core pin 22, the lower punch 23, and the upper punch 24 can relatively move in the axial direction (up and down) with respect to the die 21. Concave-convex mold portions 25 and 25 corresponding to the shapes of the radial dynamic pressure generating portions A1 and A2 to be provided on the inner peripheral surface 10a of the green compact 10 are provided vertically apart from each other on an outer peripheral surface of the core pin 22. A concave-convex mold portion 26 corresponding to the shape of the thrust dynamic pressure generating portion B to be provided on the lower end surface 10b of the green compact 10 is provided on an upper end surface of the lower punch 23. A height difference between a concave portion and a convex portion in the mold portions 25 and 26 is actually about several μm to ten-odd but is illustrated with exaggeration in FIGS. 5A and 5B.

In the molding die device 20 having the above configuration, first, as shown in FIG. 5A, the lower punch 23 is lowered with the core pin 22 disposed on the inner periphery of the die 21, a cavity 27 is defined by an inner peripheral surface of the die 21, the outer peripheral surface of the core pin 22, and the upper end surface of the lower punch 23, and then a raw material powder M is filled in the cavity 27.

Here, a powder including as a main component a metal powder capable of forming an oxide film is used as the raw material powder M. As the metal powder, a metal powder having a higher ionization tendency than that of hydrogen is preferable, and for example, an iron powder is suitable. Further, a mixing ratio of the metal powder is arbitrary as long as the metal powder is the main component of the raw material powder. For example, a composition of the raw material powder M is preferably set such that a ratio of the metal powder to the entire raw material powder is equal to or more than 95 wt %. A substance other than a metal powder capable of forming an oxide film can be mixed in the raw material powder M. For example, a metal powder having excellent compression moldability such as a copper powder, or an amide wax-based solid lubricant powder can be mixed. Including the solid lubricant powder in the raw material powder M can reduce friction between particles of the powder during compression molding and also reduce friction between the powder and a mold to enhance the moldability of the green compact 10.

Further, a form of the metal powder is not particularly limited, and for example, a porous metal powder can be used. For example, when the metal powder is iron powder, iron powder (reduced iron powder) obtained by a reduction method can be used.

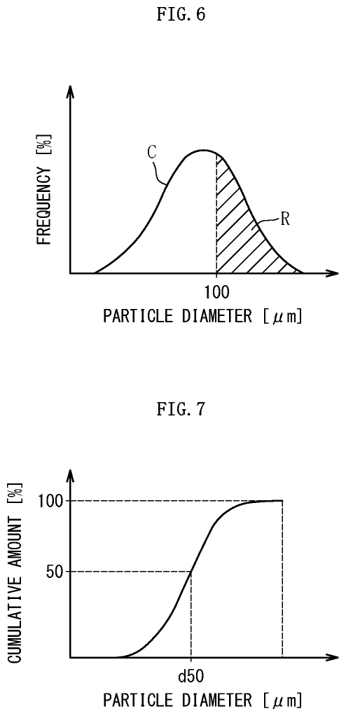

Further, from the viewpoint of a particle size distribution, in the present invention, a metal powder is used which exhibits a particle size distribution in which the ratio of the metal powder of 100 μm or more to the metal powder as a whole is 30 wt % or more, and a cumulative 50% diameter is 50 μm or more and 100 μm or less. Thus, the metal powder in the green compact 10 or the fluid dynamic bearing 8 exhibits the above particle size distribution as a whole. Here, FIG. 6 is a graph conceptually illustrating the particle size distribution of the metal powder by a frequency distribution display. FIG. 7 is a graph conceptually illustrating the particle size distribution of the metal powder by a cumulative distribution display. First, as shown in FIG. 6, when the particle size distribution of the metal powder is displayed by a frequency distribution, a group R of a metal powder having a particle diameter of 100 μm or more is equivalent to a hatched part in FIG. 6 with a particle diameter of 100 μm as a boundary. In this case, the ratio of the metal powder having a particle diameter of 100 μm or more to the metal powder as a whole is equivalent to a ratio of an area of the hatched part R to an area of a part surrounded by a curve C and a horizontal axis in FIG. 6. Thus, the ratio of the area of the hatched part R is 30% or more. Further, as shown in FIG. 7, when the particle size distribution of the metal powder is displayed by a cumulative distribution, the cumulative 50% diameter is displayed as d50 in FIG. 7. At the particle diameter d50 as a boundary, a cumulative amount % of a metal powder having a particle diameter of d50 or less and a cumulative amount % of a metal powder having a particle diameter of d50 or less become the same (each 50%). Thus, according to the particle size distribution of the metal powder of the present invention, the particle diameter d50 shown in FIG. 7 falls within a range of 50 μm or more and 100 μm or less.

While the raw material powder M including the metal powder having the above composition is filled in the cavity 27, the upper punch 24 is lowered as shown in FIG. 5B, and the raw material powder M is axially compressed to mold the green compact 10 having a cylindrical shape. At this time, a shape of the mold portion 25 is transferred to the inner peripheral surface 10a of the green compact 10, and a shape of the mold portion 26 is transferred to the lower end surface 10b of the green compact 10. As a result, at the same time as the green compact 10 having a cylindrical shape is compression-molded, the radial dynamic pressure generating portions A1 and A2 are molded on the inner peripheral surface 10a of the green compact 10, and the thrust dynamic pressure generating portion B is molded on the lower end surface 10b. When the green compact 10 is discharged from the die 21 after being molded in this way, a diameter of the inner peripheral surface 10a and a diameter of the outer peripheral surface 10d of the green compact 10 are expanded by so-called spring back. This eliminates a concave and convex engagement in the axial direction between the inner peripheral surface 10a of the green compact 10 and the mold portion 25 provided on the outer peripheral surface of the core pin 22. This enables the core pin 22 to be pulled out from an inner periphery of the green compact 10 without breaking the shape of the radial dynamic pressure generating portions A1 and A2 molded on the inner peripheral surface 10a of the green compact 10.

When the relative density of the green compact 10 as the base of the fluid dynamic bearing 8 is 80% or more, a strength required for the fluid dynamic bearing 8 (radial crushing strength of 150 MPa or more) can be eventually secured. Thus, when the uniaxial pressure molding method adopted in this embodiment is used, an axial dimension of the cavity 27 (filling height of the raw material powder M) and a uniaxial compression amount are preferably adjusted such that the relative density is 80% or more. The uniaxial pressure molding method has an advantage that the green compact 10 can be obtained at a lower cost than in other pressure molding methods that can be used for obtaining the green compact 10 (for example, a multi-axis CNC press molding, cold isostatic pressing, and hot isostatic pressing). If there is no problem about costs, a method such as the multi-axis CNC press molding, the cold isostatic pressing method, or the hot isostatic pressing method may be used instead of the uniaxial pressure molding method to mold the green compact 10.

### [Film Forming Step]

In the film forming step, a predetermined heat treatment is performed on the green compact 10 to form the oxide film 12 (see also FIG. 4) on the surfaces of the particles 11 of the metal powder configuring the green compact 10. In this embodiment, the green compact 10 is heated at a relatively low temperature in an air atmosphere (temperature lower than a sintering temperature, for example, 350° C. or higher and 600° C. or lower), and is reacted with the air for a predetermined time while being heated (low-temperature heat treatment). By subjecting the green compact 10 to the low-temperature heat treatment in the air atmosphere in this way, a film of triiron tetraoxide (Fe₃O₄) as the oxide film 12 is gradually formed on the surfaces of the particles 11 of the metal powder (here, iron powder particles) configuring the green compact 10. As the oxide film 12 grows, the green compact 10 (substantially, fluid dynamic bearing 8) in which the adjacent particles 11 are bonded to each other through the oxide film 12 can be obtained. Here, time for the low-temperature heat treatment is preferably 1 minute or more. By performing the low-temperature heat treatment for 1 minute or more, the oxide film 12 that can secure the strength required for the fluid dynamic bearing 8 can be formed on the green compact 10. However, it is preferable to set an upper limit to the time for the treatment considering a growth limit of the oxide film 12, and preferably, for example, to 60 minutes or less.

When the solid lubricant powder is mixed with the raw material powder M of the green compact 10 as in this embodiment, it is preferable to perform a degreasing treatment that removes the solid lubricant powder included in the green compact 10 before the predetermined heat treatment (low-temperature heat treatment) is performed. This promotes a growth of the oxide film 12 and makes it possible to reliably obtain the strength (radial crushing strength of 150 MPa or more) required for the fluid dynamic bearing 8. A temperature for the degreasing treatment can be arbitrarily set as long as a purpose (removal of the solid lubricant) can be achieved, and is set to, for example, 300° C. or higher. Further, the temperature for the degreasing treatment is set to 800° C. or less from the viewpoint of suppressing a dimensional change of the green compact 10 due to the heat treatment. In this case, the green compact 10 (fluid dynamic bearing 8) after the film forming step is substantially configured by only the metal powder on which the oxide film 12 is formed.

### [Oil Impregnation Step]

In the oil impregnation step, a method such as a so-called vacuum impregnation is used to impregnate internal pores of the green compact 10 having the oxide film 12 (triiron tetraoxide film) formed between the adjacent particles 11 with a lubricating oil as a lubricating fluid. Note that the oil impregnation step does not necessarily have to be performed, and may be performed only when the fluid dynamic bearing 8 is used as a so-called oil impregnated fluid dynamic bearing.

As described above, in the fluid dynamic bearing 8 of the present invention, a metal powder is used which exhibits a particle size distribution in which the ratio of the metal powder of 100 μm or more to the metal powder as a whole is 30 wt % or more, and the cumulative 50% diameter is 50 μm or more and 100 μm or less, as a metal powder that is the main component of the raw material powder M and is capable of forming the oxide film 12. Thus, by using a metal powder showing a particle size distribution in which the ratio of the metal powder of 100 μm or more to the metal powder as a whole is 30 wt % or more (see FIG. 6), it is possible to avoid occurrence of lamination as much as possible due to the mixture of a powder having a relatively fine particle diameter. Further, in addition to the above distribution, by using a metal powder having a cumulative 50% diameter of 50 μm or more and 100 μm or less in particle size distribution (see FIG. 7), the particle diameter of the metal powder is entirely increased. It is therefore possible to prevent the internal pores 13 (see FIG. 4) of the green compact 10 from becoming excessively large. As a result, for example, when the oxide film 12 is formed by the subsequent heat treatment, the formation of the oxide film 12 effectively seals or reduces the internal pores 13 (see FIG. 4), and a dynamic pressure is prevented from escaping to the inside of the fluid dynamic bearing 8 (decrease in rigidity of a lubricating oil film as a fluid film formed in the bearing gap) as much as possible. This allows desired bearing performance to be stably exhibited.

Further, the formation of the oxide film 12 on the surfaces of the particles 11 of the metal powder configuring the green compact 10 reduces the size of the internal pores 13 of the green compact 10 and a porosity of the entire green compact 10. Thus, in the fluid dynamic bearing 8 of the present invention, the fluid dynamic bearing device 1 can be obtained in which it is possible to avoid as much as possible a reduction in the rigidity of an oil film formed in the radial bearing gaps and the thrust bearing gap, and the desired bearing performance can be stably exhibited, without increasing the density (relative density) of the green compact 10 more than necessary, and without performing a separate treatment such as a sealing treatment.

In the fluid dynamic bearing 8 of the present invention, the oxide film 12 formed between the particles 11 of the metal powder functions as a binding medium between the particles 11, and takes a role of necking formed when the green compact 10 is sintered. The fluid dynamic bearing 8 thus exhibits a radial crushing strength of 150 MPa or more. The fluid dynamic bearing 8 can be thus used as it is as the fluid dynamic bearing 8 without being subjected to treatment such as sintering. This can simplify a manufacturing process and reduce manufacturing costs.

Further, in this embodiment, a reduced iron powder is used as the metal powder that is the main component of the raw material powder M. The reduced powder generally has a distorted shape (for example, a shape with great irregularities on a surface) as compared with an atomized powder. Thus, by using the reduced powder, the particles 11 of the metal powder as the reduced powder are closely entangled during green compacting, and the green compact 10 having a high strength can be obtained. Further, because iron is a metal having a high ionization tendency, the oxide film 12 can be effectively formed between the particles 11 of the iron powder by using the iron powder as the raw material powder M. Further, an iron powder, which is available at a low price, is preferable in terms of material cost.

Further, in this embodiment, the metal powder exhibiting the above particle size distribution is used as the metal powder capable of forming the oxide film 12, and the ratio of the metal powder to the entire raw material powder M is set to 95 wt % or more. This can avoid occurrence of lamination and more effectively suppress a decrease in dimensional accuracy (or shape accuracy) after the heat treatment for forming the film.

Further, in this embodiment, the low-temperature heat treatment is adopted as the predetermined heat treatment for forming the oxide film 12. Thus, by performing the low-temperature heat treatment on the green compact 10, while the oxide film 12 exhibiting the above particle size distribution is effectively formed between the particles 11 of the metal powder, the treatment temperature at that time can be significantly lower than a heating temperature when the green compact 10 is sintered (generally from 750° C. to 1,050° C.). As a result, an amount of dimensional change of the green compact 10 after the heat treatment can be reduced, and a shaping process such as sizing can be omitted. The low treatment temperature can reduce the energy required for the treatment, which leads to a cost reduction.

Although one embodiment of the present invention has been described above, the fluid dynamic bearing device 1 and the method of manufacturing the same of the present invention are not limited to the above-described exemplary embodiment, and may take any arbitrary configuration within the scope of the present invention.

In the above embodiment, the case has been described where the raw material powder M including one kind of metal powder (for example, iron powder) is used as the metal powder capable of forming the oxide film 12. Alternatively, the raw material powder M of the present invention may include two or more kinds of metal powder capable of forming the oxide film 12. Further, at least one kind of metal powder may be included in the raw material powder M as a main component, and the mixing ratio of the other kinds of metal powder is arbitrary.

Further, in the above embodiment, the case where the present invention is applied to the fluid dynamic bearing 8 that supports the shaft member 2 in the radial direction and the thrust direction (precisely, one thrust direction) has been described. However, the present invention is applicable to the fluid dynamic bearing 8 that supports the shaft member 2 only in the radial direction, and the fluid dynamic bearing 8 that supports the shaft member 2 only in the thrust direction. Further, a form of the radial dynamic pressure generating portions A1 and A2 is not particularly limited as long as the radial dynamic pressure generating portions A1 and A2 can generate a dynamic pressure action on the lubricating oil in the radial bearing gaps. For example, a known form such as a multi-arc surface, a step surface, or a corrugated surface can be adopted. The thrust dynamic pressure generating portion B can also adopt a known form such as a step surface or a corrugated surface.

Further, in the above embodiment, the fluid dynamic bearing device 1 in which the fluid dynamic bearing 8 is fixed to the inner peripheral surface of the housing 7 has been exemplified. However, the fluid dynamic bearing 8 of the present invention is applicable to the fluid dynamic bearing device 1 that has a form different from the above form. For example, although not shown in the drawings, the fluid dynamic bearing 8 may be axially held with the seal member 9 and the housing 7, and the seal member 9 may be fixed to the inner periphery of the housing 7 to fix the fluid dynamic bearing 8 to the housing 7.

### EXAMPLES

Hereinafter, Examples (verification tests) for verifying the effects of the present invention will be described in detail. In the verification tests, the green compact 10 was molded using the molding die device 20 shown in FIGS. 5A and 5B. Further, as the metal powder capable of forming the oxide film 12 used at that time, four kinds of reduced iron powders having different cumulative 50% diameters (Examples 1 and 2 and Comparative Examples 1 and 2) were used. A laser diffraction and scattering particle size distribution measuring device (LMS-300 manufactured by Seishin Enterprise Co., Ltd.) was used to measure the cumulative 50% diameter (particle size distribution). Table 1 shows values of cumulative 50% diameters of various reduced iron powders. When the particle size distribution of these reduced iron powders is seen by the frequency distribution display, reduced iron powders were used which exhibited a particle size distribution in which the ratio of the reduced iron powders having a particle diameter of 100 μm or more was 30 wt % or more in Examples 1 and 2 and Comparative Example 2. A reduced iron powder was used which exhibited a particle size distribution in which the ratio of the reduced iron powder having a particle diameter of 100 μm or more was 23 wt % in Comparative Example 1 The mixing ratio of the various reduced iron powders to the entire raw material powder M was 95 wt % or more, the rest of which was solid lubricant powder. The four kinds of raw material powders M having the above composition were compression-molded such that the relative density was 85% to produce the green compact 10. After that, each green compact 10 was subjected to the low-temperature heat treatment in the air atmosphere under conditions of 350° C. to 600° C. (preferably, 450° C. to 600° C.)×1 to 60 minutes (preferably, 1 to 30 minutes) to form the oxide film 12 between the surfaces of the reduced iron powder particles and between the particles. Thus, the fluid dynamic bearing 8 was obtained. At this time, the size of the test pieces (fluid dynamic bearing 8 in Examples or Comparative Examples) was set to an inner diameter of 1.5 mm×an outer diameter of 3 mm×an axial dimension of 3.3 mm. During the compression molding, the radial dynamic pressure generating portions A1 and A2 (see FIG. 2) were molded on the inner peripheral surface 10a at the same time when the green compact 10 was molded.

TABLE 1

| | Cumulative 50% | Presence or absence | Oil |
|---|---|---|---|
| | diameter [μm] | of lamination | permeability |
| Example 1 | 92 | Absent | Good |
| Example 2 | 83 | Absent | Good |
| Comparative | 48 | Present | Good |
| Example 1 | | | |
| Comparative | 108 | Absent | Poor |
| Example 2 | | | |

It was first confirmed whether lamination was present or absent on a surface of each of the four types of test pieces (fluid dynamic bearings 8) prepared as described above. Further, oil permeability of each of the above-mentioned four types of test pieces (fluid dynamic bearing 8) was measured and calculated. Since a value of the oil permeability depends on a size of a test object, the calculated oil permeability was used to calculate transmittance which is usable as a basis for determining a capacity of forming an oil film regardless of the size of the test object.

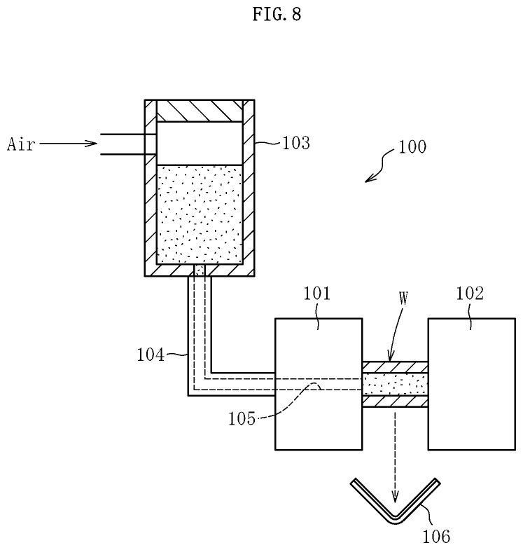

Here, the “oil permeability” is a parameter [unit: g/10 min] that quantitatively indicates how much an object having a porous structure (fluid dynamic bearing 8) allows the lubricating oil to flow through the porous texture. The oil permeability can be measured using a test device 100 as shown in FIG. 8. The test device 100 shown in FIG. 8 includes cylindrical holders 101 and 102 that hold and fix a cylindrical test object W (here, the above-described fluid dynamic bearing 8) from both sides in the axial direction, a tank 103 that stores oil, and a pipe 104 that supplies the oil stored in the tank 103 to the holder 101. A seal body (not shown) seals between both axial ends of the test object W and the holders 101 and 102. In the above configuration, a pressure force of 0.4 MPa is applied to the oil stored in the tank 103 under a room temperature (from 26° C. to 27° C.) (lubricating oil of the same kind as the lubricating oil filled in the internal space of the fluid dynamic bearing device 1). The lubricating oil is continuously supplied to an axial through hole of the test object W through an internal channel of the pipe 104 and an internal channel 105 of the holder 101 for 10 minutes. An oil absorber 106 made of paper or cloth is disposed below the test object W, and collects oil exuded and dropped from an opening on a surface that opens to an outer surface of the test object W when the lubricating oil is supplied to the test object W in the above-described mode. Then, the oil permeability is calculated from a weight difference of the oil absorber 106 before and after the test.

Next, the “transmittance” can also be referred to as a transmission amount [unit: m²], and is calculated from the following Equation 1.

$$- K = - \frac{μ}{2 π L} \cdot \frac{ln ( \frac{{r}_{1}}{{r}_{2}} )}{Δ p} \cdot q \qquad [ Equation 1 ]$$

In Equation 1, k: transmittance [m²], μ: absolute viscosity of the lubricating oil [Pa·s], L: axial dimension of the test object W [m], r1: inner diameter dimension of the test object W [m], r2: outer diameter dimension [m] of the test object W, Δp: pressure difference [Pa], and q: volume flow rate [m³/s] are satisfied. However, the pressure difference Δp referred to here is expressed by Δp=0.4 MPa in accordance with a measurement procedure of the “oil permeability” described above. The volume flow rate q is obtained by converting the “oil permeability” calculated using the above test device 100. Here, when a value of the oil permeability obtained by the above procedure was smaller than 0.01 g/10 min, the value was evaluated as good. When the value was 0.01 g/10 min or more, the value was evaluated as poor.

The test results are shown in Table 1. As shown in Table 1, when the reduced iron powder was used which exhibited a particle size distribution in which a cumulative 50% diameter was less than 50 μm (Comparative Example 1: 48 μm), presence of lamination was confirmed on the surface of the test piece (fluid dynamic bearing 8). On the other hand, when the reduced iron powders were used which exhibited a particle size distribution in which a cumulative 50% diameter was 50 μm or more and 100 μm or less (Example 1: 92 Example 2: 83 μm), presence of lamination was not confirmed on the surface of the test piece (fluid dynamic bearing 8). Further, regarding the oil permeability, when the particle diameter was excessively large as a whole (Comparative Example 2), a considerable number of internal pores 13 that are not sufficiently sealed or reduced by the formation of the oxide film 12 remained. As a result, the required oil permeability was not obtained. On the other hand, when the reduced iron powder exhibiting a particle size distribution of an appropriate size (Example 1 and Example 2) was used, the internal pores 13 were effectively and sufficiently sealed or reduced by the formation of the oxide film 12. Thus, the required oil permeability was obtained.

1. A fluid dynamic bearing comprising:
a green compact of a raw material powder including a metal powder as a main component capable of forming an oxide film;
a dynamic pressure generating portion provided in a region of a surface of the green compact where a bearing gap is formed between the surface of the green compact and a supported portion; and
the oxide film formed between particles of the metal powder,
the fluid dynamic bearing having a radial crushing strength of 150 MPa or more,
wherein the metal powder exhibits a particle size distribution in which a ratio of the metal powder of 100 μm or more to the metal powder as a whole is 30 wt % or more, and a cumulative 50% diameter is 50 μm or more and 100 μm or less.

2. The fluid dynamic bearing according to claim 1, wherein the metal powder is a reduced powder.

3. The fluid dynamic bearing according to claim 1, wherein the metal powder is an iron powder.

4. The fluid dynamic bearing according to claim 1, wherein the ratio of the metal powder to the raw material powder as a whole is 95 wt % or more.

5. The fluid dynamic bearing according to claim 1, wherein an internal pore of the green compact is impregnated with a lubricating oil.

6. A fluid dynamic bearing device comprising:
the fluid dynamic bearing described in claim 1; and
a shaft member that includes the supported portion and rotates relative to the fluid dynamic bearing.

7. A motor comprising the fluid dynamic bearing device described in claim 6.

8. A method of manufacturing a fluid dynamic bearing having a radial crushing strength of 150 MPa or more, the method comprising:
a compression molding step of compressing a raw material powder including as a main component a metal powder capable of forming an oxide film to mold a green compact, and molding a dynamic pressure generating portion in a region in which a bearing gap is formed between a surface of the green compact and a supported portion; and
a film forming step of performing a predetermined heat treatment on the green compact, and forming the oxide film between particles of the metal powder configuring the green compact,
wherein as the metal powder, a metal powder is used which exhibits a particle size distribution in which a ratio of the metal powder of 100 μm or more to the metal powder as a whole is 30 wt % or more, and a cumulative 50% diameter is 50 μm or more and 100 μm or less.

9. The method of manufacturing a fluid dynamic bearing according to claim 8, wherein, in the film forming step, the green compact is subjected to a low-temperature heat treatment in an air atmosphere as the predetermined heat treatment.

10. The method of manufacturing a fluid dynamic bearing according to claim 9, wherein a treatment temperature for the low-temperature heat treatment is set to 350° C. or higher and 600° C. or lower.

11. The fluid dynamic bearing according to claim 2, wherein the metal powder is an iron powder.

12. The fluid dynamic bearing according to claim 2, wherein the ratio of the metal powder to the raw material powder as a whole is 95 wt % or more.

13. The fluid dynamic bearing according to claim 3, wherein the ratio of the metal powder to the raw material powder as a whole is 95 wt % or more.

14. The fluid dynamic bearing according to claim 11, wherein the ratio of the metal powder to the raw material powder as a whole is 95 wt % or more.

15. The fluid dynamic bearing according to claim 2, wherein an internal pore of the green compact is impregnated with a lubricating oil.

16. The fluid dynamic bearing according to claim 3, wherein an internal pore of the green compact is impregnated with a lubricating oil.

17. The fluid dynamic bearing according to claim 4, wherein an internal pore of the green compact is impregnated with a lubricating oil.

18. The fluid dynamic bearing according to claim 11, wherein an internal pore of the green compact is impregnated with a lubricating oil.

19. The fluid dynamic bearing according to claim 12, wherein an internal pore of the green compact is impregnated with a lubricating oil.

20. The fluid dynamic bearing according to claim 13, wherein an internal pore of the green compact is impregnated with a lubricating oil.
